(19) United States
(12) Patent Application Publication
(10) Pub. No.: US 2022/0291714 A1
(43) Pub. Date: Sep. 15, 2022

(54) DOCKING STATION

(71) Applicant: Primax Electronics Ltd., Taipei (TW)

(72) Inventors: Wen-Chih Chu, Taipei (TW); Seng-Wei Shu, Taipei (TW); Yu-Chuan Liu, Taipei (TW)

(21) Appl. No.: 17/544,899

(22) Filed: Dec. 7, 2021

(30) Foreign Application Priority Data
Mar. 12, 2021 (TW) 110202712

(51) Int. Cl. G06F 1/16; G06F 13/38; G06F 13/40

(52) U.S. Cl. CPC G06F 1/1632; G06F 13/385; G06F 13/4081; G06F 2213/0042

(57) ABSTRACT

A docking station includes a first stand, a second stand and a main body. The first stand is contactable with a plane. The second stand is contactable with the plane. The main body is arranged between the first stand and the second stand. The main body includes a pivotal part and a support part. A first end and a second end of the pivotal part are respectively connected with the first stand and the second stand. The support part is connected with the pivotal part and contacted with the plane. In addition, there is an included angle between the support part and the first stand or between the support part and the second stand.

### FIELD OF THE INVENTION

The present invention relates to a docking station, and more particularly to a foldable docking station.

### BACKGROUND OF THE INVENTION

Nowadays, electronic devices such as notebook computers are developed toward slimness, the numbers of connecting ports installed in the electronic devices are gradually reduced. Consequently, a docking station that allows to provide one-to-many signals and power output becomes a popular peripheral product.

In some situations, the user needs to carry the docking station. However, the conventional docking station is not equipped with any improved design to meet this need.

### SUMMARY OF THE INVENTION

For solving the drawbacks of the conventional technologies, the present invention provides a foldable docking station. The docking station can be selectively in a closed status or an opened status. The docking station can be easily carried by the user. In addition, an electronic device can be leant against on the docking station at a desired inclination angle. Consequently, the operating convenience of the docking station is enhanced.

In accordance with an aspect of the present invention, a docking station is provided. The docking station includes a first stand, a second stand and a main body. The first stand is contactable with a plane. The second stand is contactable with the plane. The main body is arranged between the first stand and the second stand. The main body includes a pivotal part and a support part. A first end and a second end of the pivotal part are respectively connected with the first stand and the second stand. The support part is connected with the pivotal part and contacted with the plane. In addition, there is an included angle between the support part and the first stand or between the support part and the second stand.

In an embodiment, an interior space and an exterior space of the docking station are defined by the support part, the pivotal part, the first stand and the second stand according to the included angle. The interior space is a space inside a range corresponding to the included angle. The exterior space is a space outside the range corresponding to the included angle.

In an embodiment, the pivotal part of the main body further includes at least one first connecting port and an opening corresponding to the at least one first connecting port. The opening faces the exterior space.

In an embodiment, the docking station further includes a magnetically-attractable cover, and the opening is covered by the magnetically-attractable cover.

In an embodiment, the pivotal part of the main body includes a first connecting port, and the first stand includes a second connecting port. The first connecting port is a power input port. The second connecting port is a power output port.

In an embodiment, the first stand further includes a status indication lamp, and the status indication lamp is arranged around the second connecting port.

In an embodiment, the second stand further includes a rotation locking button. The second connecting port, the pivotal port and the rotation locking button are aligned with a same axial line.

In an embodiment, the support part of the main body further includes a speaker, and the speaker is located at an end of the support part away from the pivotal part.

In an embodiment, the docking station further includes a control panel, and the control panel is installed on the pivotal part.

In an embodiment, the control panel is a luminous touch strip.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a docking station according to an embodiment of the present invention;

FIG. 2 is a schematic perspective view illustrating the docking station as shown in FIG. 1 and taken along another viewpoint;

FIG. 3 is a schematic perspective view illustrating the docking station as shown in FIG. 1 and in a closed status; and

FIGS. 4A, 4B and 4C are schematic side views illustrating the docking station as shown in FIG. 1, in which the open angles are different.

### DETAILED DESCRIPTION OF THE PREFERRED EMBODIMENT

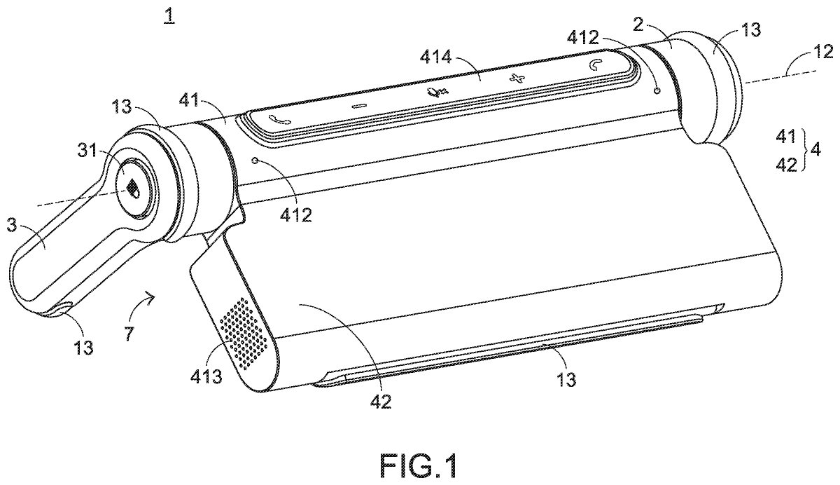

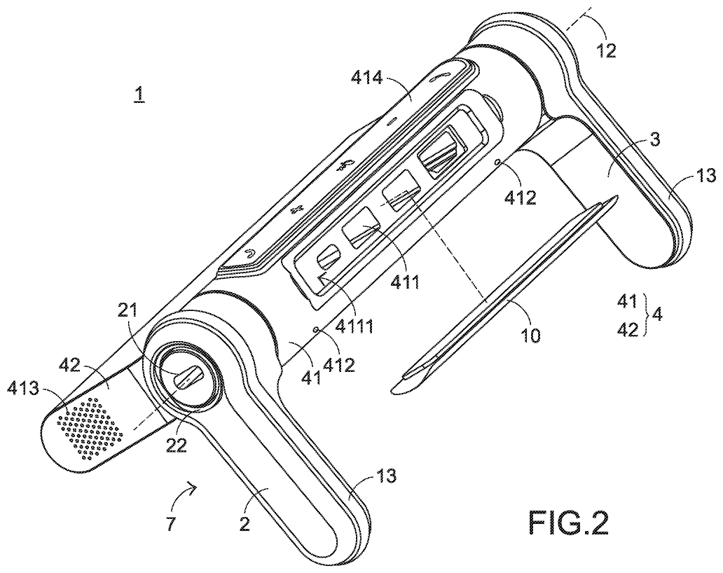

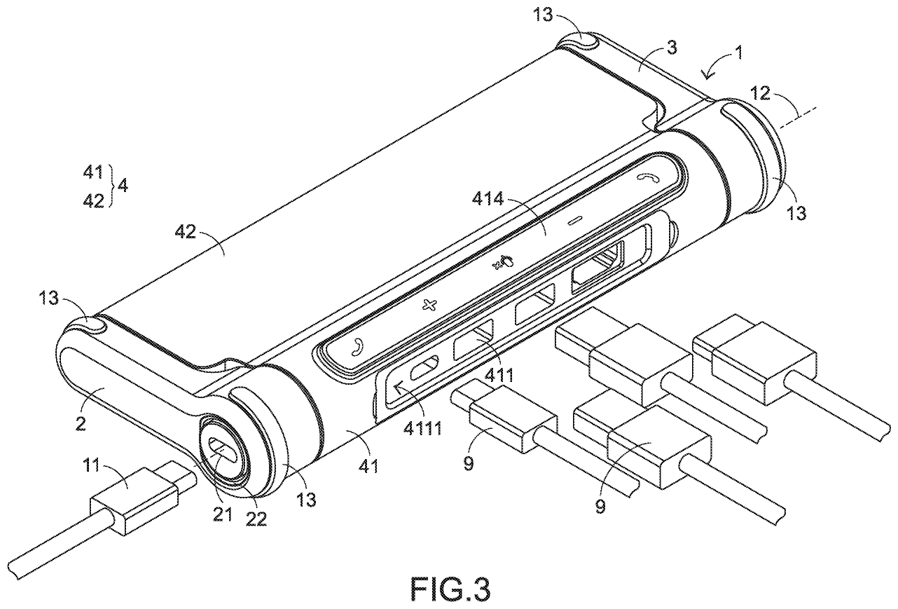

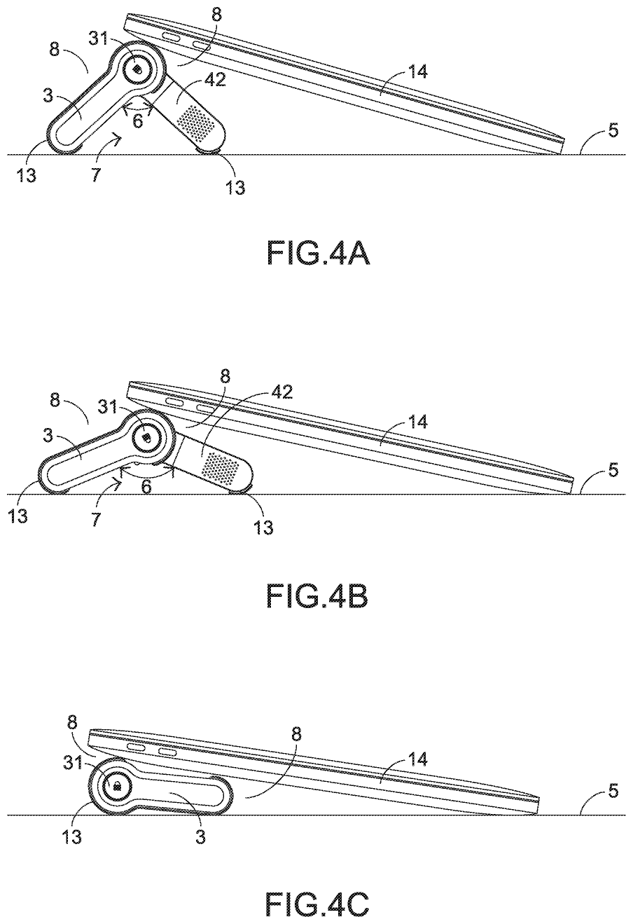

The present invention provides a docking station. Please refer to FIGS. 1, 2, 3, 4A, 4B and 4C. FIG. 1 is a schematic perspective view illustrating a docking station according to an embodiment of the present invention. FIG. 2 is a schematic perspective view illustrating the docking station as shown in FIG. 1 and taken along another viewpoint. FIG. 3 is a schematic perspective view illustrating the docking station as shown in FIG. 1 and in a closed status. FIGS. 4A, 4B and 4C are schematic side views illustrating the docking station as shown in FIG. 1, in which the open angles are different. As shown in these drawings, the docking station 1 comprises a first stand 2, a second stand 3 and a main body 4. The main body 4 is arranged between the first stand 2 and the second stand 3.

The main body 4 comprises a pivotal part 41 and a support part 42. The first end and the second end of the pivotal part 41 are connected with the first stand 2 and the second stand 3, respectively. The support part 42 is connected with the pivotal part 41. In addition, the support part 42 is extended externally from the pivotal part 41.

The docking station 1 has a foldable design. Consequently, the docking station 1 is selectively in a closed status or an opened status. As shown in FIGS. 1, 2, 4A and 4B, the docking station 1 is in the opened status. Under this circumstance, the first stand 2, second stand 3 and the support part 42 of the main body 4 are contacted with the same plane 5. In addition, there is an included angle 6 between the support part 42 and the first stand 2 or between the support part 42 and the second stand 3. Due to the included angle 6, an interior space 7 and an exterior space 8 of the docking station 1 are defined by the support part 42, the pivotal part 41, the first stand 2 and the second stand 3 collaboratively. The interior space 7 is the space inside the range corresponding to the included angle 6. The exterior space 8 is the space outside the range corresponding to the included angle 6. The docking station 1 of the present invention can be adjusted to have one of plural different open angles. When an electronic device is supported on the docking station 1, the inclination angle of the electronic device is adjusted according to the open angle of the docking station 1. Consequently, the flexibility of operating the electronic device by the user is enhanced.

Please refer to FIG. 3. When the docking station 1 of the present invention is in the closed status, the first stand 2 and the second stand 3 are aligned with the support part 42. Consequently, the support 42 is hidden between the first stand 2 and the second stand 3. Under this circumstance, the included angle between the support part 42 and the first stand 2 or between the support stand 42 and the second stand 3 is equal to 0 degree or close to 0 degree. When the docking station 1 is in the closed status, the occupied space of the docking station 1 is reduced. Consequently, the docking station 1 can be carried by the user more easily.

Please refer to FIG. 3 again. The pivotal part 41 of the main body 4 is equipped with at least one first connecting port 411. For example, the first connecting port 411 is a power input port or a signal input port, e.g., a USB interface or a HDMI interface. After a corresponding connector 9 (e.g., a USB connector or a HDMI connector) is plugged into and connected with the first connecting port 411, electric power or signals can be inputted into the docking station 1. After the connection between the electronic device and the docking station 1 is established through a connecting wire, the purposes of providing the audio-visual multimedia playback, the personal remote conference or the multi-person conference can be achieved. Consequently, the concept of the multi-functional integration for business work or leisure can be implemented.

In addition, the pivotal part 41 of the main body 4 has an opening 4111 corresponding to the at least one first connecting port 411. The opening 4111 faces the exterior space 8. Consequently, regardless of whether the docking station 1 is in the closed status or the opened status, the connector 9 can be easily plugged into the first connecting port 411.

Please refer to FIG. 2 again. In this embodiment, the docking station 1 further comprises a magnetically-attractable cover 10. The shape and size of the magnetically-attractable cover 10 match the shape and size of the opening 4111. In case that no connector 9 is plugged into the first connecting port 411, the opening 4111 is covered by the magnetically-attractable cover 10. Consequently, the dustproof and protective efficacy is enhanced. In addition, a magnet (not shown) or a magnetic element (not shown) is disposed within the opening 4111 in order to attract the magnetically-attractable cover 10.

Especially, the docking station 1 of the present invention can be used to provide the functions of making a call, having a meeting or outputting sound. As shown in FIGS. 1 and 2, the pivotal part 41 of the main body 4 is equipped with at least one microphone 412, and the support part 42 of the main body 4 is equipped with at least one speaker 413. For example, the speaker 413 is located at an end of the support part 42 away from the pivotal part 41. For example, in case that the docking station 1 is used in a conference, the microphone 412 can receive sound and the speaker 413 can output sound. Consequently, the function of having a meeting is achieved.

Please refer to FIGS. 1 and 2 again. In an embodiment, the docking station 1 further comprises a control panel 414. The control panel 414 is installed on the pivotal part 41 of the main body 4. Moreover, since the control panel 414 faces the exterior space 8, the control panel 414 can be operated by the user more easily. In this embodiment, the control panel 414 is a luminous touch strip. It is noted that the example of the control panel 414 is not restricted. That is, the type of the control panel 414 may be varied according to the requirements of the user. Moreover, the control panel 414 has specified control icons according to the practical requirements. For example, in case that the docking station 1 is used as a multimedia playback medium, the control panel with the icons “Playback”, “Pause”, “Previous”, “Next”, “Volume up”, “Volume down” and any other appropriate icons is suitably used as the control panel 414. In case that the docking station 1 is used as a medium of having a meeting, the control panel with the icons “Answer call”, “Hand up”, “Mute”, “Volume up”, “Volume down” and any other appropriate icons is suitably used as the control panel 414.

In an embodiment, the control panel 414 is made of rubbery material. Consequently, when an electronic device is placed on the docking station 1, the control panel 414 can provide anti-slipping and positioning functions.

Please refer to FIGS. 1 and 2 again. As mentioned above, the docking station 1 comprises the first stand 2 and the second stand 3. The first stand 2 and the second stand 3 are pivotally coupled to the main body 4. In an embodiment, the first stand 2 is equipped with a second connecting port 21. For example, the second connecting port 21 is a power output port or a signal output port, e.g., a USB interface. After a corresponding connector 11 (e.g., a USB connector) is plugged into and connected with the second connecting port 21, electric power or signals can be outputted to another electronic device.

In an embodiment, the second stand 3 further comprises a rotation locking button 31 for controlling the rotation relationship between the second stand 3 and the main body 4. When the user intends to adjust the included angle between the second stand 3 and the main body 4, the user may first press down the rotation locking button 31. Consequently, the rotation locking button 31 is in an unlocked status. Meanwhile, the user may adjust the included angle between the second stand 3 and the main body 4 to the desired angle. When the rotation locking button 31 is no longer pressed by the user, the rotation locking button 31 is restored to the locked state. Consequently, the included angle between the second stand 3 and the main body 4 is maintained at the fixed angle. In an embodiment, the docking station 1 further comprises a linking mechanism (not shown) between the first stand 2 and the second stand 3. When the rotation locking button 31 installed on the second stand 3 is operated by the user, the included angle between the first stand 2 and the main body 4 is correspondingly adjusted through the linking mechanism.

In an embodiment, the second connecting port 21 of the first stand 2, the pivotal port 41 of the main body 4 and the rotation locking button 31 on the second stand 3 are aligned with the same axial line. This design is helpful for the layout of the inner structure and the wiring structure of the docking station 1.

Please refer to FIG. 2 again. In an embodiment, the docking station 1 is further equipped with a status indication lamp 22. The status indication lamp 22 is arranged around the second connecting port 21. The status indication lamp 22 can be enabled to indicate various usage statuses, the connection status or the connected object of the docking station 1. For example, the status indication lamp 22 may prompt the user that the docking station 1 is connected to the notebook computer or the mobile phone at this moment. Moreover, since the status indication lamp 22 is arranged around the second connecting port 21, the status indication lamp 22 can provide a ring-shaped luminous effect.

In an embodiment, the docking station 1 further comprises plural anti-slip pads 13. These anti-slip pads 13 are installed on the first stand 2, the second stand 3 and the support part 42. When the docking station 1 is placed on the plane 5, the anti-slip pads 13 provide the anti-slip function. When the electronic device is placed on the docking station 1, these anti-slip pads 13 can also provide the positioning function. Moreover, in case that the anti-slip pads 13 are wrapped around the first stand 2 and the second stand 3 in a large range and at a large angle, the docking station 1 can be cooperatively used with electronic devices with various sizes. Consequently, the docking station 1 and the electronic device can be securely positioned on the plane (e.g., a desk surface).

FIGS. 4A, 4B and 4C are schematic side views illustrating the docking station as shown in FIG. 1, in which the open angles are different. When an electronic device 14 is leant against the docking station 1, the operating angle of the electronic device 14 can be adjusted according to the open angle of the docking station 1. For example, the electronic device 14 is a notebook computer. As shown in FIGS. 4A and 4B, the electronic device 14 is leant against the docking station 1. Meanwhile, the bottom surface of the electronic device 14 is leant against the anti-slip pads 13 on the first stand (not shown) and the second stand 3. As the included angle between the support part 42 and the second stand 3 of the docking station 1 is adjusted (e.g., from the situation of FIG. 4A to the situation of FIG. 4B), the inclination angle of the electronic device 14 with respect to the plane 5 is adjusted. When the docking station 1 is in the closed state (e.g., in the situation of FIG. 4C), the electronic device 14 is leant against the anti-slip pads 13 on the first stand (not shown), the second stand 3 and the support part 42. Similarly, the inclination angle of the electronic device 14 with respect to the plane 5 is fixed.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A docking station, comprising:
a first stand contactable with a plane;
a second stand contactable with the plane; and
a main body arranged between the first stand and the second stand, and comprising a pivotal part and a support part, wherein a first end and a second end of the pivotal part are respectively connected with the first stand and the second stand, the support part is connected with the pivotal part and contacted with the plane, and there is an included angle between the support part and the first stand or between the support part and the second stand.

2. The docking station according to claim 1, wherein an interior space and an exterior space of the docking station are defined by the support part, the pivotal part, the first stand and the second stand according to the included angle, wherein the interior space is a space inside a range corresponding to the included angle, and the exterior space is a space outside the range corresponding to the included angle.

3. The docking station according to claim 2, wherein the pivotal part of the main body further comprises at least one first connecting port and an opening corresponding to the at least one first connecting port, wherein the opening faces the exterior space.

4. The docking station according to claim 3, wherein the docking station further comprises a magnetically-attractable cover, and the opening is covered by the magnetically-attractable cover.

5. The docking station according to claim 2, wherein the pivotal part of the main body comprises a first connecting port, and the first stand comprises a second connecting port, wherein the first connecting port is a power input port, and the second connecting port is a power output port.

6. The docking station according to claim 5, wherein the first stand further comprises a status indication lamp, and the status indication lamp is arranged around the second connecting port.

7. The docking station according to claim 5, wherein the second stand further comprises a rotation locking button, wherein the second connecting port, the pivotal port and the rotation locking button are aligned with a same axial line.

8. The docking station according to claim 1, wherein the support part of the main body further comprises a speaker, and the speaker is located at an end of the support part away from the pivotal part.

9. The docking station according to claim 1, wherein the docking station further comprises a control panel, and the control panel is installed on the pivotal part.

10. The docking station according to claim 9, wherein the control panel is a luminous touch strip.
